(19) United States
(12) Patent Application Publication
(10) Pub. No.: US 2025/0031152 A1
(43) Pub. Date: Jan. 23, 2025

(54) ENERGY RESERVATION FOR A RADIO OF A USER EQUIPMENT

(71) Applicant: QUALCOMM Incorporated, San Diego, CA (US)

(72) Inventors: Yahia RAMADAN, San Jose, CA (US); Farhad MESHKATI, San Diego, CA (US); Huang LOU, Santee, CA (US); Tienyow LIU, Santa Clara, CA (US); Akshay KUMAR, San Diego, CA (US); Arnaud MEYLAN, San Diego, CA (US)

(21) Appl. No.: 18/641,931

(22) Filed: Apr. 22, 2024

Related U.S. Application Data
(60) Provisional application No. 63/513,994, filed on Jul. 17, 2023.

(51) Int. Cl. H04W 52/22; H04W 52/32; H04W 52/36

(52) U.S. Cl. CPC H04W 52/223; H04W 52/325; H04W 52/367

(57) ABSTRACT

Various aspects of the present disclosure generally relate to wireless communication. In some aspects, a user equipment (UE) may determine, for a radio associated with the UE, an energy usage in a past transmit interval. The UE may determine, for the radio, a requested usage-aware energy reservation based at least in part on the energy usage in the past transmit interval. The UE may assign, for a next transmit interval, an energy budget limit for the radio based at least in part on the requested usage-aware energy reservation. The UE may transmit, via the radio, an uplink transmission based at least in part on the energy budget limit. Numerous other aspects are described.

### CROSS-REFERENCE TO RELATED APPLICATION

This patent application claims priority to U.S. Provisional Patent Application No. 63/513,994, filed on Jul. 17, 2023, entitled “ENERGY RESERVATION FOR A RADIO OF A USER EQUIPMENT,” and assigned to the assignee hereof. The disclosure of the prior Application is considered part of and is incorporated by reference into this patent application.

### FIELD OF THE DISCLOSURE

Aspects of the present disclosure generally relate to wireless communication and to techniques and apparatuses for energy reservation for a radio of a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication includes one or more memories; and one or more processors coupled to the one or more memories, the one or more processors individually or collectively configured to: determine, for a radio associated with a user equipment (UE), an energy usage in a past transmit interval; determine, for the radio, a requested usage-aware energy reservation based at least in part on the energy usage in the past transmit interval; assign, for a next transmit interval, an energy budget limit for the radio based at least in part on the requested usage-aware energy reservation; and transmit, via the radio, an uplink transmission based at least in part on the energy budget limit.

In some implementations, an apparatus for wireless communication includes one or more memories; and one or more processors coupled to the one or more memories, the one or more processors individually or collectively configured to: determine, for a radio of a plurality of radios associated with a UE, a requested normalized energy reservation; determine, for the radio, a final normalized energy reservation based at least in part on a sum of requested normalized energy reservations, associated with the plurality of radios, and a predefined maximum total normalized energy reservation; determine, for the radio, an energy usage in a past transmit interval; determine, for a next transmit interval, an energy budget limit for the radio based at least in part on the final normalized energy reservation and the energy usage in the past transmit interval; and transmit, via the radio, an uplink transmission based at least in part on the energy budget limit.

In some implementations, a method of wireless communication performed by a UE includes determining, for a radio associated with the UE, an energy usage in a past transmit interval; determining, for the radio, a requested usage-aware energy reservation based at least in part on the energy usage in the past transmit interval; assigning, for a next transmit interval, an energy budget limit for the radio based at least in part on the requested usage-aware energy reservation; and transmitting, via the radio, an uplink transmission based at least in part on the energy budget limit.

In some implementations, a method of wireless communication performed by a UE includes determining, for a radio of a plurality of radios associated with the UE, a requested normalized energy reservation; determining, for the radio, a final normalized energy reservation based at least in part on a sum of requested normalized energy reservations, associated with the plurality of radios, and a predefined maximum total normalized energy reservation; determining, for the radio, an energy usage in a past transmit interval; determining, for a next transmit interval, an energy budget limit for the radio based at least in part on the final normalized energy reservation and the energy usage in the past transmit interval; and transmitting, via the radio, an uplink transmission based at least in part on the energy budget limit.

In some implementations, a non-transitory computer-readable medium storing a set of instructions for wireless communication includes one or more instructions that, when executed by one or more processors of a UE, cause the UE to: determine, for a radio associated with the UE, an energy usage in a past transmit interval; determine, for the radio, a requested usage-aware energy reservation based at least in part on the energy usage in the past transmit interval; assign, for a next transmit interval, an energy budget limit for the radio based at least in part on the requested usage-aware energy reservation; and transmit, via the radio, an uplink transmission based at least in part on the energy budget limit.

In some implementations, a non-transitory computer-readable medium storing a set of instructions for wireless communication includes one or more instructions that, when executed by one or more processors of a UE, cause the UE to: determine, for a radio of a plurality of radios associated with the UE, a requested normalized energy reservation; determine, for the radio, a final normalized energy reservation based at least in part on a sum of requested normalized energy reservations, associated with the plurality of radios, and a predefined maximum total normalized energy reservation; determine, for the radio, an energy usage in a past transmit interval; determine, for a next transmit interval, an energy budget limit for the radio based at least in part on the final normalized energy reservation and the energy usage in the past transmit interval; and transmit, via the radio, an uplink transmission based at least in part on the energy budget limit.

In some implementations, an apparatus for wireless communication includes means for determining, for a radio associated with the apparatus, an energy usage in a past transmit interval; means for determining, for the radio, a requested usage-aware energy reservation based at least in part on the energy usage in the past transmit interval; means for assigning, for a next transmit interval, an energy budget limit for the radio based at least in part on the requested usage-aware energy reservation; and means for transmitting, via the radio, an uplink transmission based at least in part on the energy budget limit.

In some implementations, an apparatus for wireless communication includes means for determining, for a radio of a plurality of radios associated with the apparatus, a requested normalized energy reservation; means for determining, for the radio, a final normalized energy reservation based at least in part on a sum of requested normalized energy reservations, associated with the plurality of radios, and a predefined maximum total normalized energy reservation; means for determining, for the radio, an energy usage in a past transmit interval; means for determining, for a next transmit interval, an energy budget limit for the radio based at least in part on the final normalized energy reservation and the energy usage in the past transmit interval; and means for transmitting, via the radio, an uplink transmission based at least in part on the energy budget limit.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-6 are diagrams illustrating examples associated with energy reservation for a radio of a UE, in accordance with the present disclosure.

FIGS. 7-8 are diagrams illustrating example processes associated with energy reservation for a radio of a UE, in accordance with the present disclosure.

FIG. 9 is a diagram of an example apparatus for wireless communication, in accordance with the present disclosure.

### DETAILED DESCRIPTION

An uplink transmission power of a radio may be restricted by a regulatory specification. The radio may be a sub-6 GHz radio or a millimeter wave radio. The regulatory specification may be defined as a specific absorption rate (SAR) in a sub-6 GHz band, and/or as a maximum permissible exposure (MPE) on a human body in a millimeter wave band. SAR and MPE are designed to project the human body from radio frequency (RF) exposure. SAR and MPE may be different radio exposure requirements in different frequency bands. MPE may be in terms of power density (PD). A limit on SAR and MPE should not be counted separately, and instead, should be counted together because both SAR and MPE affect the human body. A sum of a normalized SAR exposure and a normalized PD (e.g., a PD as an MPE measurement in a millimeter wave band) should not be greater than one.

A radio may utilize only a portion of a normalized exposure margin to maintain a reserve energy level for continuous transmission. A user equipment (UE) may need to share a total available energy among a plurality of sub-6 GHz and/or millimeter wave radios, of the UE, based at least in part on an MPE/SAR requirement, in a next transmission interval. For heavy uplink traffic applications, reserving energy for the radio based at least in part on only control and high-priority traffic data may be insufficient to maintain a high sustainable transmit power, which may result in a lower average throughput as compared to a higher reserve energy. The lower average throughput may degrade an overall performance of the UE.

Various aspects relate generally to energy reservations for radios of a UE. Some aspects more specifically relate to a per-radio energy usage aware dynamic energy reservation (EUA-DER) under MPE/SAR limits. In some examples, a UE may determine, for a radio associated with the UE, an energy usage in a past transmit interval. The UE may determine, for the radio, a requested usage-aware energy reservation based at least in part on the energy usage in the past transmit interval (e.g., actual energy usage by the radio in the past). The UE may assign, for a next transmit interval, an energy budget limit for the radio based at least in part on the requested usage-aware energy reservation. The UE may transmit, to a network node and via the radio, an uplink transmission based at least in part on the energy budget limit.

In some examples, a UE may determine, for a radio of a plurality of radios associated with the UE, a requested normalized energy reservation. The UE may determine, for the radio, a final normalized energy reservation based at least in part on a sum of requested normalized energy reservations, associated with the plurality of radios, and a predefined maximum total normalized energy reservation. The UE may determine, for the radio, an energy usage in a past transmit interval. The UE may determine, for a next transmit interval, an energy budget limit for the radio based at least in part on the final normalized energy reservation and the energy usage in the past transmit interval. The UE may transmit, via the radio, an uplink transmission based at least in part on the energy budget limit.

Particular aspects of the subject matter described in this disclosure can be implemented to realize one or more of the following potential advantages. In some examples, by implementing the per-radio EUA-DER under MPE/SAR limits, the described techniques can be used to guarantee higher reserve energy levels for continuous uplink transmissions associated with heavy uplink traffic applications, as compared to when such an approach is not implemented (e.g., only considering the required energy for the radio to transmit the control and high-priority traffic data). The EUA-DER may exploit advantages of total energy limits of MPE/SAR, where each radio may dynamically request energy based at least in part on the actual energy usage by the radio in the past and based at least in part on the required energy for the radio to transmit the control and high-priority traffic for control channels and high-priority traffic data, which may allow the radio to be assigned an appropriate amount of energy, thereby improving a performance of the radio. In a multi-radio scenario, energy may be distributed based at least in part on the priority of each radio and the usage-aware energy reservation requests while meeting predefined minimum energy reservations. Higher priority radios may be assigned more energy than lower priority radios, while meeting the predefined minimum energy reservations, thereby improving an overall performance of the multiple radios of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

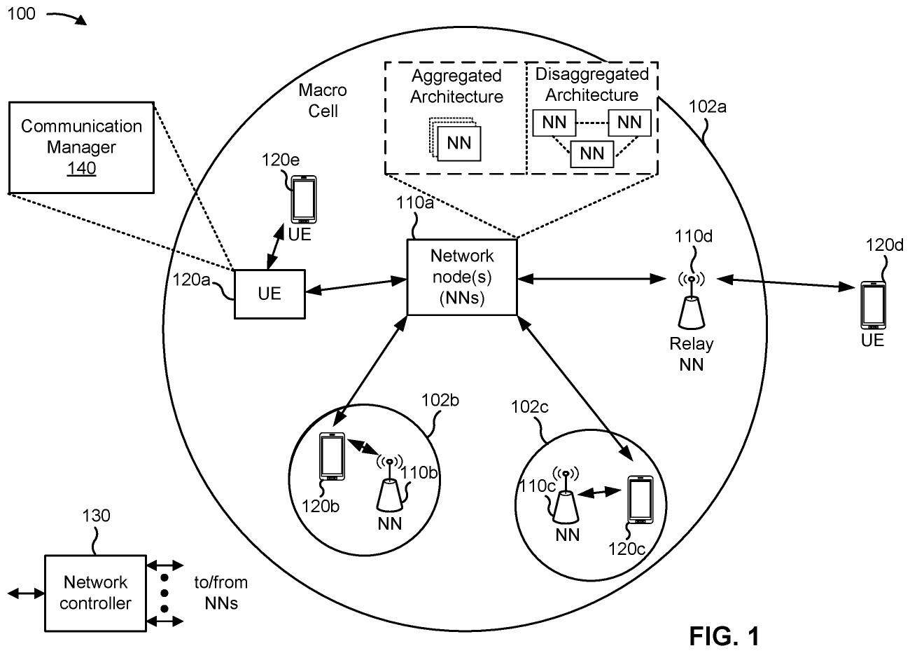

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may determine, for a radio associated with the UE, an energy usage in a past transmit interval; determine, for the radio, a requested usage-aware energy reservation based at least in part on the energy usage in the past transmit interval; assign, for a next transmit interval, an energy budget limit for the radio based at least in part on the requested usage-aware energy reservation; and transmit, via the radio, an uplink transmission based at least in part on the energy budget limit. As described in more detail elsewhere herein, the communication manager 140 may determine, for a radio of a plurality of radios associated with the UE, a requested normalized energy reservation; determine, for the radio, a final normalized energy reservation based at least in part on a sum of requested normalized energy reservations, associated with the plurality of radios, and a predefined maximum total normalized energy reservation; determine, for the radio, an energy usage in a past transmit interval; determine, for a next transmit interval, an energy budget limit for the radio based at least in part on the final normalized energy reservation and the energy usage in the past transmit interval; and transmit, via the radio, an uplink transmission based at least in part on the energy budget limit. Additionally, or alternatively, the communication manager 140 may perform one or more other operations described herein.

As indicated above, FIG. 1 is provided as an example. Other examples may differ from what is described with regard to FIG. 1.

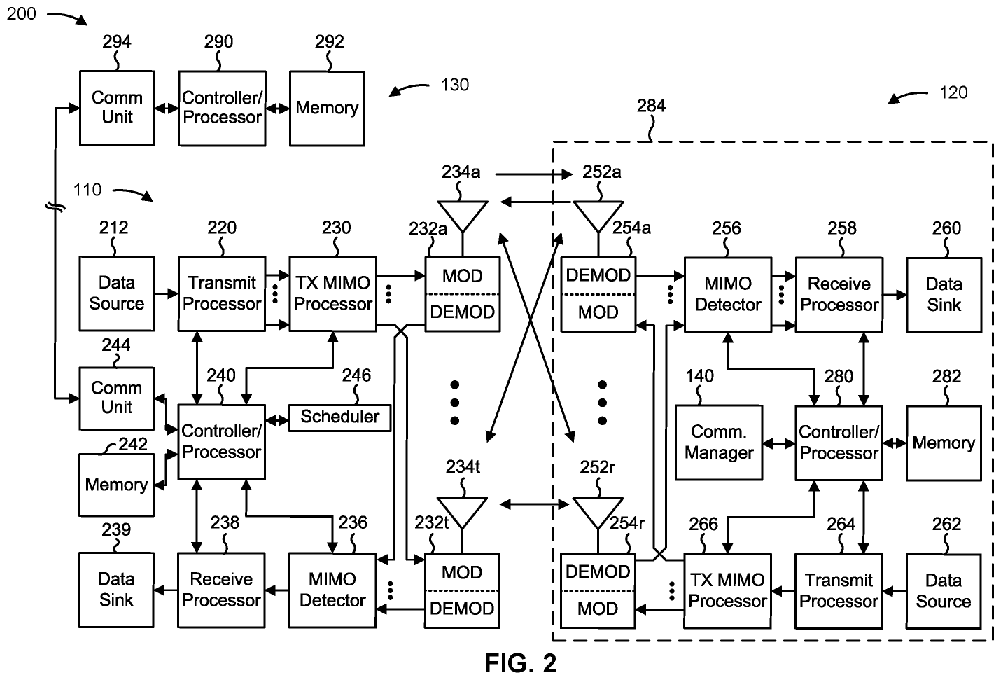

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

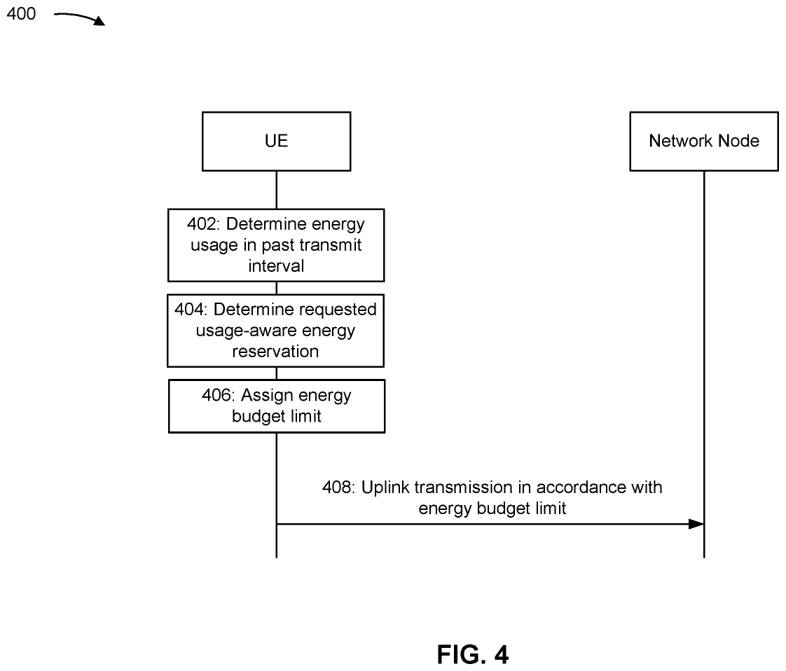

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

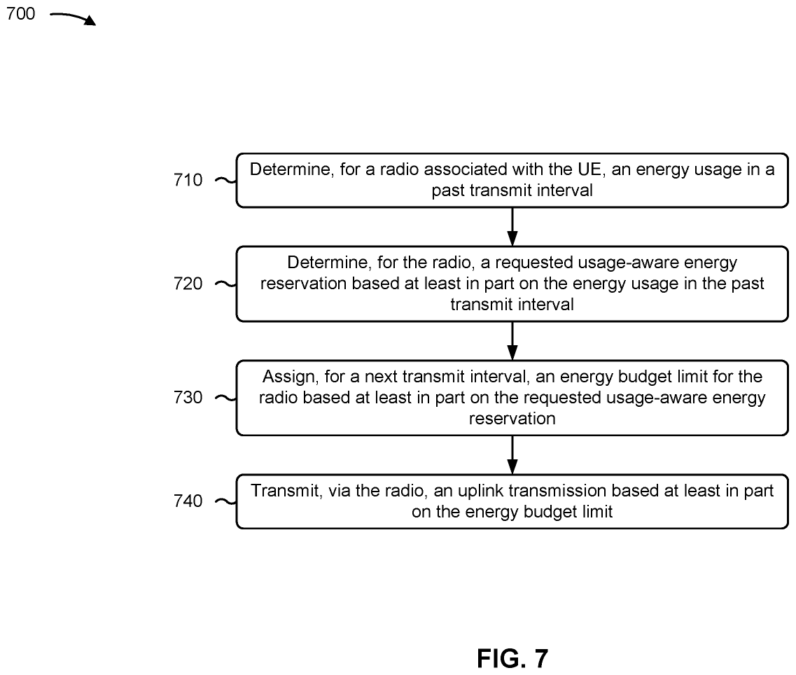

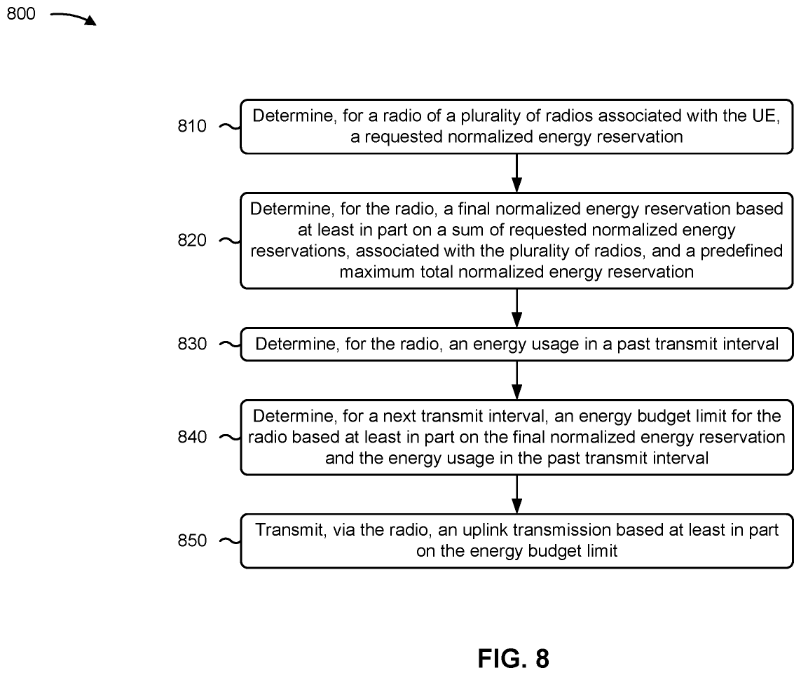

The controller/processor 240 of the network node 110, the controller/processor 280 of the UE 120, and/or any other component(s) of FIG. 2 may perform one or more techniques associated with energy reservation for a radio of a UE, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for determining, for a radio associated with the UE, an energy usage in a past transmit interval; means for determining, for the radio, a requested usage-aware energy reservation based at least in part on the energy usage in the past transmit interval; means for assigning, for a next transmit interval, an energy budget limit for the radio based at least in part on the requested usage-aware energy reservation; and/or means for transmitting, via the radio, an uplink transmission based at least in part on the energy budget limit. In some aspects, the UE includes means for determining, for a radio of a plurality of radios associated with the UE, a requested normalized energy reservation; means for determining, for the radio, a final normalized energy reservation based at least in part on a sum of requested normalized energy reservations, associated with the plurality of radios, and a predefined maximum total normalized energy reservation; means for determining, for the radio, an energy usage in a past transmit interval; means for determining, for a next transmit interval, an energy budget limit for the radio based at least in part on the final normalized energy reservation and the energy usage in the past transmit interval; and/or means for transmitting, via the radio, an uplink transmission based at least in part on the energy budget limit. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

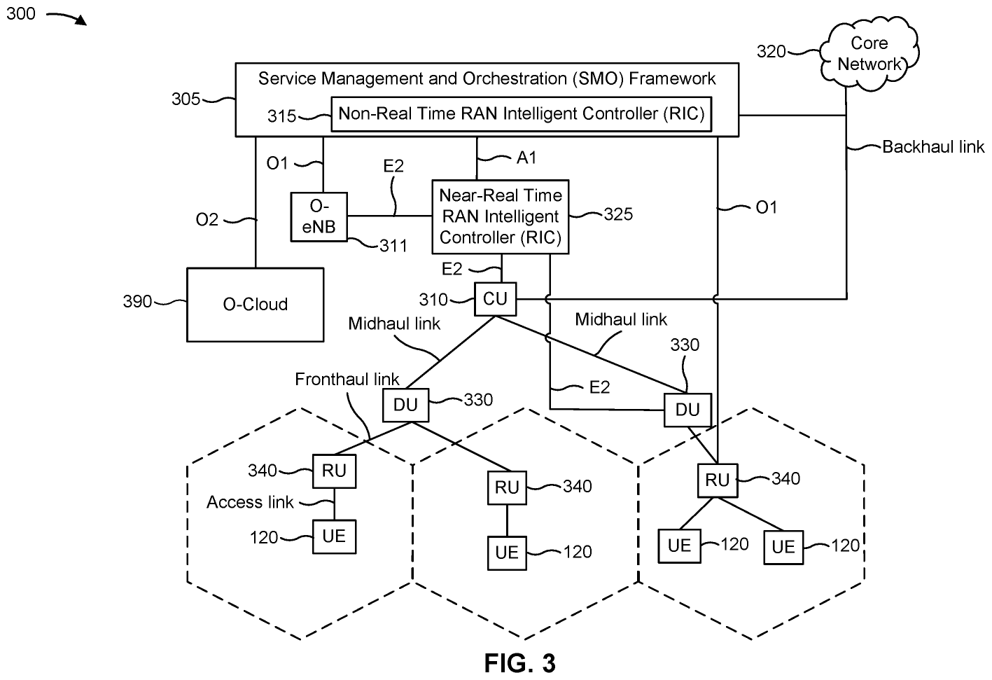

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An uplink transmission power of a radio may be restricted by a regulatory specification. The radio may be an LTE radio, an NR sub-6 GHz radio, a millimeter wave radio, a WiFi radio, or a Bluetooth radio. The regulatory specification may be defined as a SAR in a sub-6 GHz band, and/or as an MPE on a human body in a millimeter wave band. SAR and MPE are designed to project the human body from RF exposure. SAR and MPE may be different radio exposure requirements in different frequency bands. SAR and MPE may be defined by international regulators, such as the International Commission on Non-Ionizing Radiation Protection (ICNIRP) and the Federal Communications Commission (FCC) in the United States. MPE may be in terms of PD. A limit on SAR and MPE should not be counted separately, and instead, they should be counted together because both SAR and MPE affect the human body. A sum of a normalized SAR exposure and a normalized PD (e.g., a PD as an MPE measurement in a millimeter wave band) should not be greater than one across an averaging time window, in accordance with:

$${\sum }_{i = 100 kHz}^{10 GHz} \frac{{SAR}_{i}}{{SAR}_{stdlim}} + {\sum }_{i = 10 GHz}^{300 GHz} \frac{{PD}_{i}}{{PD}_{stdlim}} \leq 1 ,$$

where SAR_{stdlim} is a total limit for SAR, and PD_{stdlim} is a total limit for PD. The normalized SAR exposure may be summed over a range of 10 kHz to 100 GHz. The normalized PD may be summed over a range of 10 GHz to 300 GHZ.

The normalized SAR exposure and the normalized PD may be greater than one for an instantaneous transmission, but an average of the normalized SAR exposure and the normalized PD across a plurality of uplink transmissions should be less than or equal to one during the averaging time window in order to satisfy a regulatory requirement. With energy reservation, the radio may initially transmit with a relatively high power, but then switch to a relatively low power, such that the average of the normalized SAR exposure and the normalized PD is less than or equal to one during the averaging time window. Energy reservation may involve dropping to the relatively low power. Such an approach may be useful for bursty traffic (e.g., non-continuous traffic), in which a higher transmit power may be needed for relatively short period of times, and no transmissions may occur at other times, such that the average of the normalized SAR exposure and the normalized PD is still less than or equal to one during the averaging time window.

The radio may utilize only a portion of a normalized exposure margin to maintain a reserve energy level for a continuous transmission. A UE may need to share a total available energy among a plurality of sub-6 GHz and/or millimeter wave radios based at least in part on an MPE/SAR requirement in a next transmission interval. For heavy uplink traffic applications, reserving energy for the radio based at least in part on only control and high-priority traffic data may be insufficient to maintain a high sustainable transmit power, which may result in a lower average throughput as compared to a higher reserve energy. The lower average throughput may degrade an overall performance of the UE. For example, when the radio reserves energy based at least in part on only control and high-priority traffic data, the radio may transmit at a transmit power higher than a reference input maximum transmit power for a certain duration of time, but then drop to a relatively lower power compared to the reference input maximum transmit power for a next duration of time, in order to satisfy the regulatory requirement. In this case, an average throughput may be lower than if the radio maintained a higher stable transmit power for an entire duration of time (e.g., transmit at a power higher than a reference input maximum transmit power for a relatively short duration of time and then at a slightly lower power compared to the reference input maximum transmit power for a remaining time). The reference input maximum transmit power may be a maximum allowed power for the radio under a corresponding transmit antenna based at least in part on an uplink duty cycle satisfying a threshold (e.g., when the uplink duty cycle is 100%) and the radio being an only active radio of the UE. The lower average throughput may degrade the performance for heavy uplink traffic applications.

In various aspects of techniques and apparatuses described herein, a UE may determine, for a radio associated with the UE, an energy usage in a past transmit interval. The UE may determine, for the radio, a requested usage-aware energy reservation based at least in part on the energy usage in the past transmit interval. The UE may assign, for a next transmit interval, an energy budget limit for the radio based at least in part on the requested usage-aware energy reservation. The UE may transmit, to a network node and via the radio, an uplink transmission based at least in part on the energy budget limit.

In various aspects of techniques and apparatuses described herein, a UE may determine, for a radio of a plurality of radios associated with the UE, a requested normalized energy reservation. The UE may determine, for the radio, a final normalized energy reservation based at least in part on a sum of requested normalized energy reservations, associated with the plurality of radios, and a predefined maximum total normalized energy reservation. The UE may determine, for the radio, an energy usage in a past transmit interval. The UE may determine, for a next transmit interval, an energy budget limit for the radio based at least in part on the final normalized energy reservation and the energy usage in the past transmit interval. The UE may transmit, via the radio, an uplink transmission based at least in part on the energy budget limit.

In some aspects, the radio of the UE may implement an EUA-DER. A dynamic energy reserve level of the radio may be based at least in part on an actual energy usage by the radio in the past, and based at least in part on a required energy for the radio to transmit control and high-priority traffic data. In other words, both the actual energy usage by the radio in the past and the required energy for the radio to transmit the control and high-priority traffic data may be considered when determining the dynamic energy reserve level. The dynamic energy reserve level may involve dynamically changing energy reserve levels based at least in part on an uplink traffic load. In some aspects, when multiple radios are present in the UE (e.g., a multi-radio scenario), each radio may be guaranteed a predefined minimum energy reservation. Any extra available energy reservation may be distributed between radios based at least in part on priorities of the radios, actual past energy usage, and/or energy reservation required for control channels and high priority services.

In some aspects, for the EUA-DER, a filtered normalized energy (NE) usage may be calculated by filtering the ratio between an energy usage and an allocated energy budget (e.g., not just the energy usage). The EUA-DER may involve boosting a dynamic reserve based at least in part on the filtered NE usage. The EUA-DER may involve handling best-effort traffic data in case of a usage-aware dynamic reserve, which may involve keeping best-effort traffic data that is based at least in part on an energy limit and a true requested reservation. In some aspects, in an energy reservation arbitration, and in the multi-radio scenario, a baseline algorithm may be implemented, which may involve distributing extra reservations beyond a minimum reserve based at least in part on the priorities of the radios and usage-aware energy reservation requests.

In some aspects, the EUA-DER may exploit advantages of total energy limits of MPE/SAR, where each radio may dynamically request energy based at least in part on the actual energy usage by the radio in the past and based at least in part on the required energy for the radio to transmit the control and high-priority traffic for control channels and high-priority traffic data, which may allow the radio to be assigned an appropriate amount of energy, thereby improving a performance of the radio. For heavy uplink traffic applications, the EUA-DER may guarantee a higher reserve energy level for a continuous transmission, as compared to only considering the required energy for the radio to transmit the control and high-priority traffic data. The EUA-DER may achieve a higher average uplink throughput for heavy uplink traffic applications while meeting regulatory specifications. In some aspects, in the multi-radio scenario, energy may be distributed based at least in part on the priority of each radio and the usage-aware energy reservation requests while meeting predefined minimum energy reservations. Higher priority radios may be assigned more energy than lower priority radios, while meeting the predefined minimum energy reservations, thereby improving an overall performance of the multiple radios of the UE.

FIG. 4 is a diagram illustrating an example 400 associated with energy reservation for a radio of a UE, in accordance with the present disclosure. As shown in FIG. 4, example 400 includes communication between a UE (e.g., UE 120) and a network node (e.g., network node 110). In some aspects, the UE and the network node may be included in a wireless network, such as wireless network 100.

In some aspects, the UE may include one or more radios. A radio (e.g., radio j), of the one or more radios associated with the UE, may be associated with an EUA-DER module, an uplink (UL) transmission (TX) module, and a MAC module. The UE may include an MPE/SAR energy budget arbitrator. The UE may be configured with multiple antenna groups, and the radio may be associated with an antenna group of the multiple antenna groups. The radio may be associated with EUA-DER under a MPE/SAR limit. A dynamic energy reserve level of the radio may be based at least in part on actual past energy usage by the radio and required energy for the radio to transmit control data and the high-priority traffic.

As shown by reference number 402, the UE may determine, for the radio, an energy usage in a past transmit interval (E_{usage,j}). For example, the uplink transmission module may calculate the energy usage in the past transmit interval, which the uplink transmission module may report to the EUA-DER module. The energy usage in the past transmit interval may be a non-filtered energy usage in the past transmit interval. In some cases, the UE may filter the energy usage in the past interval to obtain a filtered energy usage in the past transmit interval.

As shown by reference number 404, the UE may determine, for the radio, a requested usage-aware energy reservation (E_{usage,rsv,j}) based at least in part on the energy usage in the past transmit interval. The UE may calculate, for a transmit interval, a normalized energy usage ratio (NE_{usage,ratio,j}) as a ratio between the energy usage in the past transmit interval and a minimum of an allocated energy limit in the past transmit interval and a reference input maximum transmit energy limit (E_{ref,lim,j}). The normalized energy usage ratio may be less than or equal to one. The normalized energy usage ratio may be a filtered normalized energy usage ratio (NE_{usage,filt,j}) or a non-filtered normalized energy usage ratio. The reference input maximum transmit energy limit may be a maximum allowed energy limit for the radio under a corresponding transmit antenna based at least in part on an uplink duty cycle satisfying a threshold (e.g., when the uplink duty cycle is 100%) and the radio being an only active radio of the UE.

In some aspects, the UE may calculate the requested usage-aware energy reservation based at least in part on the normalized energy usage ratio multiplied by the reference input maximum transmit energy limit. In some aspects, the UE may obtain a filtered normalized energy usage ratio, from the normalized energy usage ratio, using a filter. The UE may calculate the requested usage-aware energy reservation based at least in part on the filtered normalized energy usage ratio multiplied by the reference input maximum transmit energy limit.

In some aspects, the UE may determine a true requested energy reservation (E_{true,rsv,j}) for a control channel and high-priority traffic. The true requested energy reservation may be based at least in part on a sum of a control channel energy reservation (E_{ctrl,j}) and a requested high-priority traffic energy reservation (E_{hp,j}). The UE may calculate the requested usage-aware energy reservation based at least in part on the true requested energy reservation.

In some aspects, the UE may determine the true requested energy reservation for the control channel and high-priority traffic. The UE may calculate the requested usage-aware energy reservation based at least in part on a maximum of the true requested energy reservation and the normalized energy usage ratio multiplied by the reference input maximum transmit energy limit.

In some aspects, the UE may determine the true requested energy reservation for the control channel and high-priority traffic. The UE may obtain the filtered normalized energy usage ratio (NE_{usage,filt,j}), from the normalized energy usage ratio, using a filter. The UE may calculate the requested usage-aware energy reservation based at least in part on a maximum of the true requested energy reservation and the filtered normalized energy usage ratio multiplied by the reference input maximum transmit energy limit.

In some aspects, the uplink transmission module may calculate the energy usage in the past transmit interval, and the uplink transmission module may report the energy usage in the past transmit interval to the EUA-DER module. The EUA-DER module may report the energy usage in the past transmit interval to the MPE/SAR energy budget arbitrator. In some aspects, in every transmit interval, the EUA-DER module may calculate the normalized energy usage ratio as the ratio between the energy usage in the past transmit interval and the minimum of the allocated energy limit in the past interval and the reference input maximum transmit energy limit. The normalized energy usage ratio may be capped at one. The reference input maximum transmit energy limit may be the reference maximum transmit energy limit when the uplink duty cycle is 100% and only that radio is active.

In some aspects, the EUA-DER module may update the filtered normalized energy usage ratio based at least in part on the normalized energy usage ratio using a filter. The EUA-DER module may calculate the true requested energy reservation as the sum of the control channel energy reservation and the requested high-priority traffic energy reservation (e.g., a MAC requested energy reservation for high-priority traffic). The EUA-DER module may calculate the requested usage-aware energy reservation as the maximum of the filtered energy usage and the true requested energy reservation for the control channel and for the high-priority traffic. The filtered energy usage may be calculated by multiplying the filtered normalized energy usage ratio and the reference input maximum transmit energy limit. The EUA-DER module may send the requested usage-aware energy reservation to the MPE/SAR energy budget arbitrator. In every transmit interval, the uplink transmission module may compute an available energy limit for best-effort traffic data (E_{data,j}), and the uplink transmission module may send the available energy limit for best-effort traffic data to the MAC module of the radio.

As shown by reference number 406, the UE may assign, for a next transmit interval, an energy budget limit (E_{lim,j}) for the radio based at least in part on the requested usage-aware energy reservation, where the requested usage-aware energy reservation may be based at least in part on the energy usage in the past transmit interval. In some aspects, the UE may determine the available energy limit for best-effort traffic data. The available energy limit for best-effort traffic data may be a function of the energy budget limit and the true requested energy reservation. The available energy limit for best-effort traffic data may correspond to a remaining available transmit energy for best-effort traffic. The available energy limit for best-effort traffic data may be a function of the energy budget limit minus the true requested energy reservation (e.g., E_{lim,j}−E_{true,rsv,j}), which may correspond to remaining energy for best-effort traffic.

In some aspects, for the next transmit interval, the MPE/SAR energy budget arbitrator may calculate the energy budget limit for the radio based at least in part on the requested usage-aware energy reservation (e.g., a received EUA-DER request) and/or the past energy usage from the radio. The energy budget limit may need to satisfy the EUA-DER requests from all radios of the UE when a total energy budget is sufficient to satisfy an MPE/SAR compliance. The MPE/SAR energy budget arbitrator may indicate the energy budget limit to the uplink transmission module. The uplink transmission module should not exceed the energy budget limit for the next transmit interval. The uplink transmission module may compute an actual uplink transmit power based at least in part on the energy budget limit from the MPE/SAR energy budget arbitrator.

As shown by reference number 408, the UE may transmit, to the network node and via the radio, an uplink transmission based at least in part on the energy budget limit. The uplink transmission may be a continuous uplink transmission. The uplink transmission may be associated with a heavy uplink traffic application. By transmitting the uplink transmission based at least in part on the energy budget limit, which may be based at least in part on EUA-DER, the uplink transmission may be associated with a relatively high average uplink throughput.

As indicated above, FIG. 4 is provided as an example. Other examples may differ from what is described with regard to FIG. 4.

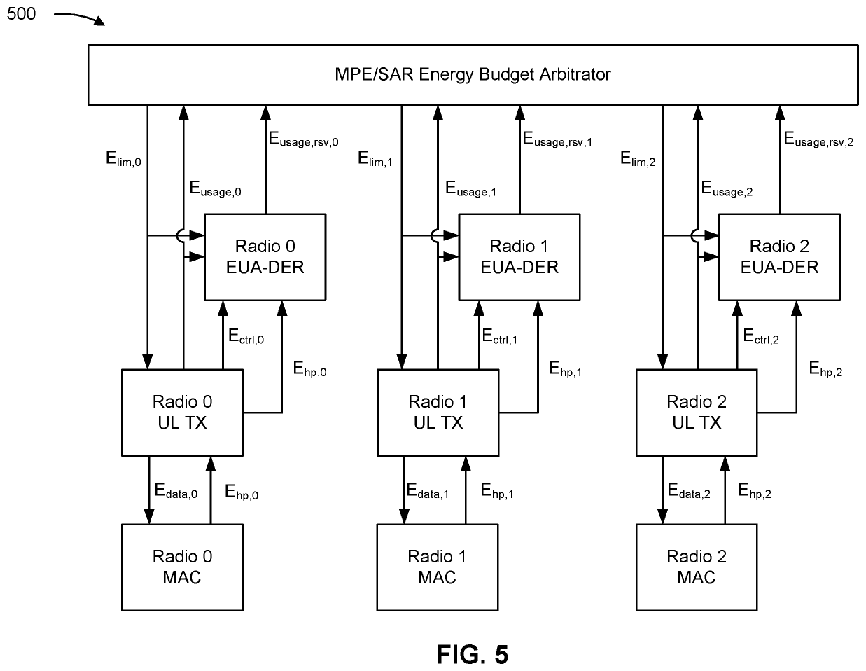

FIG. 5 is a diagram illustrating an example 500 associated with energy reservation for a radio of a UE, in accordance with the present disclosure.

In some aspects, for an EUA-DER, a UE may be configured with multiple antenna groups (AGs). Each antenna group may be associated with one or more radios. The UE may perform a procedure for EUA-DER for each antenna group. For example, the UE may include three radios, and the UE may perform the procedure for EUA-DER for the three radios (e.g., Radio 0, Radio 1, and Radio 2). A radio (e.g., radio j), of the one or more radios, may be associated with an EUA-DER module, an uplink (UL) transmission (TX) module, and a MAC module. For example, Radio 0 may be associated with Radio 0 EUA-DER, Radio 0 UL TX, and Radio 0 MAC. The UE may include an MPE/SAR energy budget arbitrator.

In some aspects, the UE may include an MPE/SAR energy budget arbitrator. The MPE/SAR energy budget arbitrator may assign a maximum energy limit for the radio (E_{lim,j}) to transmit in a next transmission interval subject to an MPE/SAR requirement, where E_{lim,j} is the maximum energy limit of the radio from the MPE/SAR energy budget arbitrator. The EUA-DER module may request, from the MPE/SAR energy budget arbitrator, a usage-aware energy reservation for the radio (E_{usage,rsv,j}), where E_{usage,rsv,j} is the EUA-DER of the radio based at least in part on an actual energy usage by the radio in the past and based at least in part on an energy required for the control channels for the radio (E_{xtrl,j}) (e.g., energy reservation of control channels) and an energy required for the high-priority traffic for the radio (E_{hp,j}) (e.g., a MAC requested energy reservation for high-priority traffic).

In some aspects, as part of an EUA-DER calculation, the EUA-DER module may compute the EUA-DER of the radio. The EUA-DER module may compute a true requested energy reservation (E_{true,rsv,j}) based at least in part on the energy required for the control channels and the energy required for the high-priority traffic. The EUA-DER module may compute the usage-aware energy reservation based at least in part on a maximum between a filtered actual energy usage by the radio in a past interval (E_{usage,filt,j}) and the true requested energy reservation for the control channels and the high-priority traffic. The filtered actual energy usage in the past interval may be based at least in part on an actual energy usage by the radio in the past interval.

In some aspects, the uplink transmission module may compute an actual uplink transmit power based at least in part on the maximum energy limit, as received from the MPE/SAR energy budget arbitrator. The uplink transmission module may compute an energy usage by the radio in the past interval, and the uplink transmission module may report the energy usage to the EUA-DER module. The uplink transmission module may compute an available energy limit for best-effort traffic data (E_{data,j}), and the uplink transmission module may report the available energy limit for best-effort traffic data to the MAC module.

In some aspects, the MAC module may compute the energy required for the high-priority traffic for the radio based at least in part on a MAC requested high-priority traffic target transmit power and a duration/duty cycle. The MAC module may use the available energy limit for best-effort traffic data, as indicated by the uplink transmission module, as an indication to reflect a remaining available transmit energy for best-effort traffic.

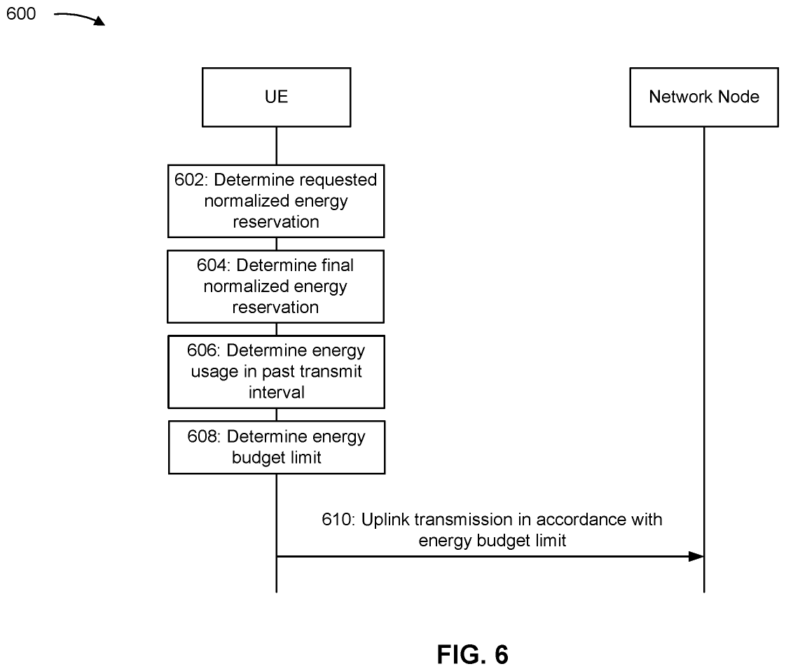

FIG. 6 is a diagram illustrating an example 600 associated with energy reservation for a radio of a UE, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

In some aspects, the UE may include one radio or a plurality of radios. A radio (e.g., radio j), of the one or plurality of radios associated with the UE, may be associated with an EUA-DER module, a UL TX module, and a MAC module. The UE may include an MPE/SAR energy budget arbitrator.

As shown by reference number 602, the UE may determine, for the radio, a requested normalized energy reservation (NE_{req,rsv,j}). The UE may allocate, for the radio, a predefined minimum normalized energy reservation (NE_{res,min,j}). In other words, the radio may be guaranteed a predefined minimum energy reservation. The requested normalized energy reservation may be a requested usage-aware energy reservation divided by a reference input maximum transmit energy limit (E_{ref,lim,j}).

In some aspects, in an energy reservation arbitration, before allocating an energy budget limit (E_{lim,j}) for the radio (e.g., each radio), the MPE/SAR energy budget arbitrator may calculate the requested normalized energy reservation, while ensuring the predefined minimum normalized energy reservation for the radio. The MPE/SAR energy budget arbitrator may calculate the requested normalized energy reservation by dividing the requested usage-aware energy reservation by the reference input maximum transmit energy limit.

As shown by reference number 604, the UE may determine, for the radio, a final normalized energy reservation (NE_{rsv,final,j}) based at least in part on a sum of requested normalized energy reservations (Σⱼ NE_{req,rsv,j}), associated with the plurality of radios, and a predefined maximum total normalized energy reservation (NE_{rsv,max}). The UE may determine whether the sum of requested normalized energy reservations, associated with the plurality of radios, exceeds the predefined maximum total normalized energy reservation. In some aspects, the sum of requested normalized energy reservations may be less than or equal to the predefined maximum total normalized energy reservation. In this case, the final normalized energy reservation may correspond to the requested normalized energy reservation. In some aspects, the sum of requested normalized energy reservations may be greater than the predefined maximum total normalized energy reservation. In this case, the final normalized energy reservation may be based at least in part on a distribution of an extra normalized energy (NE_{rsv,extra}) among the plurality of radios. The distribution may be based at least in part on priorities associated with the plurality of radios, respectively, and the requested normalized energy reservation. The extra available energy reservation may be distributed among the plurality of radios based at least in part on the priorities of the plurality of radios, actual past energy usage, and/or energy reservations for control channels and high-priority services.

In some aspects, the MPE/SAR energy budget arbitrator may ensure that a sum of requested normalized EUA-DER requests from the plurality of radios of the UE (Σⱼ NE_{req,rsv,j}) does not exceed the predefined maximum total normalized energy reservation. When Σⱼ NE_{req,rsv,j}≤NE_{rsv,max}, the final normalized energy reservation may be the same as the requested normalized energy reservation. When Σⱼ NE_{req,rsv,j}>NE_{rsv,max}, the MPE/SAR energy budget arbitrator may calculate the final normalized energy reservation. The MPE/SAR energy budget arbitrator may calculate the extra available normalized energy reservation after satisfying the predefined minimum normalized energy reservation for each radio. The MPE/SAR energy budget arbitrator may calculate the final normalized energy reservation by distributing the extra normalized energy among the plurality of radios based at least in part on priorities associated with the plurality of radios and the requested normalized energy reservation. Radios may be sorted according to the priorities of each radio. For example, a radio associated with a primary component carrier (PCC) may have a higher priority than a radio associated with a secondary component carrier (SCC), and a radio associated with a master cell group (MCG) may have a higher priority than a radio associated with a secondary cell group (SCG).

As shown by reference number 606, the UE may determine, for the radio, an energy usage in a past transmit interval (E_{usage,j}). For example, the uplink transmission module may calculate the energy usage in the past transmit interval, which the uplink transmission module may report to the EUA-DER module.

As shown by reference number 608, the UE may determine, for a next transmit interval, the energy budget limit for the radio based at least in part on the final normalized energy reservation and the energy usage in the past transmit interval. In some aspects, for the next transmit interval, the MPE/SAR energy budget arbitrator may calculate the energy budget limit for each radio based at least in part on the final normalized energy reservation and past energy usage from each radio. The energy budget limit may need to satisfy EUA-DER requests from all radios of the UE when a total energy budget is sufficient to satisfy an MPE/SAR compliance.

As shown by reference number 610, the UE may transmit, to the network node and via the radio, an uplink transmission based at least in part on the energy budget limit. The UE may transmit the uplink transmission based at least in part on an energy reservation arbitration, in which energy may be distributed based at least in part on the priority of each radio and usage-aware energy reservation requests from the plurality of radios, while meeting predefined minimum energy reservations. Further, the UE may transmit the uplink transmission based at least in part on an extra reservation beyond a minimum reserve, which may be distributed based at least in part on the priority associated with the radio.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with energy reservation for a radio of a UE.

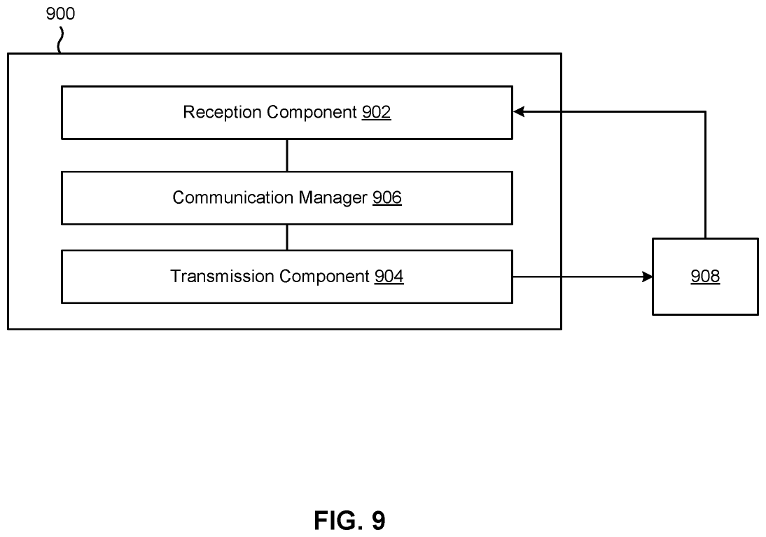

As shown in FIG. 7, in some aspects, process 700 may include determining, for a radio associated with the UE, an energy usage in a past transmit interval (block 710). For example, the UE (e.g., using communication manager 906, depicted in FIG. 9) may determine, for a radio associated with the UE, an energy usage in a past transmit interval, as described above.

As further shown in FIG. 7, in some aspects, process 700 may include determining, for the radio, a requested usage-aware energy reservation based at least in part on the energy usage in the past transmit interval (block 720). For example, the UE (e.g., using communication manager 906, depicted in FIG. 9) may determine, for the radio, a requested usage-aware energy reservation based at least in part on the energy usage in the past transmit interval, as described above.

As further shown in FIG. 7, in some aspects, process 700 may include assigning, for a next transmit interval, an energy budget limit for the radio based at least in part on the requested usage-aware energy reservation (block 730). For example, the UE (e.g., using communication manager 906, depicted in FIG. 9) may assign, for a next transmit interval, an energy budget limit for the radio based at least in part on the requested usage-aware energy reservation, as described above.

As further shown in FIG. 7, in some aspects, process 700 may include transmitting, via the radio, an uplink transmission based at least in part on the energy budget limit (block 740). For example, the UE (e.g., using transmission component 904 and/or communication manager 906, depicted in FIG. 9) may transmit, via the radio, an uplink transmission based at least in part on the energy budget limit, as described above.

Process 700 may include additional aspects, such as any single aspect or any combination of aspects described below and/or in connection with one or more other processes described elsewhere herein.

In a first aspect, process 700 includes calculating, for a transmit interval, a normalized energy usage ratio as a ratio between the energy usage in the past transmit interval and a minimum of an allocated energy limit in the past transmit interval and a reference input maximum transmit energy limit.

In a second aspect, alone or in combination with the first aspect, the normalized energy usage ratio is less than or equal to one, and the reference input maximum transmit energy limit is a maximum allowed energy limit for the radio under a corresponding transmit antenna based at least in part on an uplink duty cycle satisfying a threshold and the radio being an only active radio of the UE.

In a third aspect, alone or in combination with one or more of the first and second aspects, process 700 includes

In a fourth aspect, alone or in combination with one or more of the first through third aspects, process 700 includes calculating, for a transmit interval, a normalized energy usage ratio as a ratio between the energy usage in the past transmit interval and a minimum of an allocated energy limit in the past transmit interval and a reference input maximum transmit energy limit.

In a fifth aspect, alone or in combination with one or more of the first through fourth aspects, the normalized energy usage ratio is less than or equal to one, and the reference input maximum transmit energy limit is a maximum allowed energy limit for the radio under a corresponding transmit antenna based at least in part on an uplink duty cycle satisfying a threshold and the radio being an only active radio of the UE.

In a sixth aspect, alone or in combination with one or more of the first through third aspects, process 700 includes calculating the requested usage-aware energy reservation based at least in part on the normalized energy usage ratio multiplied by the reference input maximum transmit energy limit.

In a seventh aspect, alone or in combination with one or more of the first through sixth aspects, process 700 includes obtaining a filtered normalized energy usage ratio, from the normalized energy usage ratio, using a filter; and calculating the requested usage-aware energy reservation based at least in part on the filtered normalized energy usage ratio multiplied by the reference input maximum transmit energy limit.

In an eighth aspect, alone or in combination with one or more of the first through seventh aspects, process 700 includes determining a true requested energy reservation for a control channel and high-priority traffic, wherein the true requested energy reservation is based at least in part on a sum of a control channel energy reservation and a requested high-priority traffic energy reservation; and calculating the requested usage-aware energy reservation based at least in part on the true requested energy reservation.

In a ninth aspect, alone or in combination with one or more of the first through eighth aspects, process 700 includes determining a true requested energy reservation for a control channel and high-priority traffic, wherein the true requested energy reservation is based at least in part on a sum of a control channel energy reservation and a requested high-priority traffic energy reservation; and calculating the requested usage-aware energy reservation based at least in part on a maximum of the true requested energy reservation and the normalized energy usage ratio multiplied by the reference input maximum transmit energy limit.

In a tenth aspect, alone or in combination with one or more of the first through ninth aspects, process 700 includes determining a true requested energy reservation for a control channel and high-priority traffic, wherein the true requested energy reservation is based at least in part on a sum of a control channel energy reservation and a requested high-priority traffic energy reservation; obtaining a filtered normalized energy usage ratio, from the normalized energy usage ratio, using a filter; and calculating the requested usage-aware energy reservation based at least in part on a maximum of the true requested energy reservation and the filtered normalized energy usage ratio multiplied by the reference input maximum transmit energy limit.

In an eleventh aspect, alone or in combination with one or more of the first through tenth aspects, the radio is associated with an energy usage aware dynamic energy reservation under a SAR limit or an MPE limit, and a dynamic energy reserve level of the radio is based at least in part on actual past energy usage by the radio and required energy for the radio to transmit control data and the high-priority traffic.

In a twelfth aspect, alone or in combination with one or more of the first through eleventh aspects, the UE is configured with multiple antenna groups, and the radio is associated with an antenna group of the multiple antenna groups.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with energy reservation for a radio of a UE.

As shown in FIG. 8, in some aspects, process 800 may include determining, for a radio of a plurality of radios associated with the UE, a requested normalized energy reservation (block 810). For example, the UE (e.g., using communication manager 906, depicted in FIG. 9) may determine, for a radio of a plurality of radios associated with the UE, a requested normalized energy reservation, as described above.

As further shown in FIG. 8, in some aspects, process 800 may include determining, for the radio, a final normalized energy reservation based at least in part on a sum of requested normalized energy reservations, associated with the plurality of radios, and a predefined maximum total normalized energy reservation (block 820). For example, the UE (e.g., using communication manager 906, depicted in FIG. 9) may determine, for the radio, a final normalized energy reservation based at least in part on a sum of requested normalized energy reservations, associated with the plurality of radios, and a predefined maximum total normalized energy reservation, as described above.

As further shown in FIG. 8, in some aspects, process 800 may include determining, for the radio, an energy usage in a past transmit interval (block 830). For example, the UE (e.g., using communication manager 906, depicted in FIG. 9) may determine, for the radio, an energy usage in a past transmit interval, as described above.

As further shown in FIG. 8, in some aspects, process 800 may include determining, for a next transmit interval, an energy budget limit for the radio based at least in part on the final normalized energy reservation and the energy usage in the past transmit interval (block 840). For example, the UE (e.g., using communication manager 906, depicted in FIG. 9) may determine, for a next transmit interval, an energy budget limit for the radio based at least in part on the final normalized energy reservation and the energy usage in the past transmit interval, as described above.

As further shown in FIG. 8, in some aspects, process 800 may include transmitting, via the radio, an uplink transmission based at least in part on the energy budget limit (block 850). For example, the UE (e.g., using transmission component 904 and/or communication manager 906, depicted in FIG. 9) may transmit, via the radio, an uplink transmission based at least in part on the energy budget limit, as described above.

Process 800 may include additional aspects, such as any single aspect or any combination of aspects described below and/or in connection with one or more other processes described elsewhere herein.

In a first aspect, process 800 includes allocating, for the radio, a predefined minimum normalized energy reservation.

In a second aspect, alone or in combination with the first aspect, the requested normalized energy reservation is a requested usage-aware energy reservation divided by a reference input maximum transmit energy limit.

In a third aspect, alone or in combination with one or more of the first and second aspects, process 800 includes determining whether the sum of requested normalized energy reservations, associated with the plurality of radios, exceeds the predefined maximum total normalized energy reservation.

In a fourth aspect, alone or in combination with one or more of the first through third aspects, the sum of requested normalized energy reservations is less than or equal to the predefined maximum total normalized energy reservation, and the final normalized energy reservation corresponds to the requested normalized energy reservation.

In a fifth aspect, alone or in combination with one or more of the first through fourth aspects, the sum of requested normalized energy reservations is greater than the predefined maximum total normalized energy reservation, the final normalized energy reservation is based at least in part on a distribution of an extra normalized energy among the plurality of radios, and the distribution is based at least in part on priorities associated with the plurality of radios, respectively, and the requested normalized energy reservation.

In a sixth aspect, alone or in combination with one or more of the first through fifth aspects, the radio is guaranteed a predefined minimum energy reservation, and an extra available energy reservation is distributed among the plurality of radios based at least in part on one or more of priorities of the plurality of radios, actual past energy usage, or energy reservations for control channels and high-priority services.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may determine, for a radio associated with the UE, an energy usage in a past transmit interval. The communication manager 906 may determine, for the radio, a requested usage-aware energy reservation based at least in part on the energy usage in the past transmit interval. The communication manager 906 may assign, for a next transmit interval, an energy budget limit for the radio based at least in part on the requested usage-aware energy reservation. The transmission component 904 may transmit, via the radio, an uplink transmission based at least in part on the energy budget limit.

The communication manager 906 may determine, for a radio of a plurality of radios associated with the UE, a requested normalized energy reservation. The communication manager 906 may determine, for the radio, a final normalized energy reservation based at least in part on a sum of requested normalized energy reservations, associated with the plurality of radios, and a predefined maximum total normalized energy reservation. The communication manager 906 may determine, for the radio, an energy usage in a past transmit interval. The communication manager 906 may determine, for a next transmit interval, an energy budget limit for the radio based at least in part on the final normalized energy reservation and the energy usage in the past transmit interval. The transmission component 904 may transmit, via the radio, an uplink transmission based at least in part on the energy budget limit.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: determining, for a radio associated with the UE, an energy usage in a past transmit interval; determining, for the radio, a requested usage-aware energy reservation based at least in part on the energy usage in the past transmit interval; assigning, for a next transmit interval, an energy budget limit for the radio based at least in part on the requested usage-aware energy reservation; and transmitting, via the radio, an uplink transmission based at least in part on the energy budget limit.

Aspect 2: The method of Aspect 1, further comprising: calculating, for a transmit interval, a normalized energy usage ratio as a ratio between the energy usage in the past transmit interval and a minimum of an allocated energy limit in the past transmit interval and a reference input maximum transmit energy limit.

Aspect 3: The method of Aspect 2, wherein the normalized energy usage ratio is less than or equal to one, and the reference input maximum transmit energy limit is a maximum allowed energy limit for the radio under a corresponding transmit antenna based at least in part on an uplink duty cycle satisfying a threshold and the radio being an only active radio of the UE.

Aspect 4: The method of Aspect 2, further comprising: calculating the requested usage-aware energy reservation based at least in part on the normalized energy usage ratio multiplied by the reference input maximum transmit energy limit.

Aspect 5: The method of Aspect 2, further comprising: obtaining a filtered normalized energy usage ratio, from the normalized energy usage ratio, using a filter; and calculating the requested usage-aware energy reservation based at least in part on the filtered normalized energy usage ratio multiplied by the reference input maximum transmit energy limit.

Aspect 6: The method of any of Aspects 1-5, further comprising: determining a true requested energy reservation for a control channel and high-priority traffic, wherein the true requested energy reservation is based at least in part on a sum of a control channel energy reservation and a requested high-priority traffic energy reservation; and calculating the requested usage-aware energy reservation based at least in part on the true requested energy reservation.

Aspect 7: The method of Aspect 2, further comprising: determining a true requested energy reservation for a control channel and high-priority traffic, wherein the true requested energy reservation is based at least in part on a sum of a control channel energy reservation and a requested high-priority traffic energy reservation; and calculating the requested usage-aware energy reservation based at least in part on a maximum of the true requested energy reservation and the normalized energy usage ratio multiplied by the reference input maximum transmit energy limit.

Aspect 8: The method of Aspect 2, further comprising: determining a true requested energy reservation for a control channel and high-priority traffic, wherein the true requested energy reservation is based at least in part on a sum of a control channel energy reservation and a requested high-priority traffic energy reservation; obtaining a filtered normalized energy usage ratio, from the normalized energy usage ratio, using a filter; and calculating the requested usage-aware energy reservation based at least in part on a maximum of the true requested energy reservation and the filtered normalized energy usage ratio multiplied by the reference input maximum transmit energy limit.

Aspect 9: The method of any of Aspects 1-8, wherein the radio is associated with an energy usage aware dynamic energy reservation under a specific absorption rate (SAR) limit or a maximum permissible exposure (MPE) limit, and a dynamic energy reserve level of the radio is based at least in part on actual past energy usage by the radio and required energy for the radio to transmit control data and the high-priority traffic.

Aspect 10: The method of any of Aspects 1-9, wherein the UE is configured with multiple antenna groups, and the radio is associated with an antenna group of the multiple antenna groups.

Aspect 11: A method of wireless communication performed by a user equipment (UE), comprising: determining, for a radio of a plurality of radios associated with the UE, a requested normalized energy reservation; determining, for the radio, a final normalized energy reservation based at least in part on a sum of requested normalized energy reservations, associated with the plurality of radios, and a predefined maximum total normalized energy reservation; determining, for the radio, an energy usage in a past transmit interval; determining, for a next transmit interval, an energy budget limit for the radio based at least in part on the final normalized energy reservation and the energy usage in the past transmit interval; and transmitting, via the radio, an uplink transmission based at least in part on the energy budget limit.

Aspect 12: The method of Aspect 11, further comprising: allocating, for the radio, a predefined minimum normalized energy reservation.

Aspect 13: The method of any of Aspects 11-12, wherein the requested normalized energy reservation is a requested usage-aware energy reservation divided by a reference input maximum transmit energy limit.

Aspect 14: The method of any of Aspects 11-13, further comprising: determining whether the sum of requested normalized energy reservations, associated with the plurality of radios, exceeds the predefined maximum total normalized energy reservation.

Aspect 15: The method of Aspect 14, wherein the sum of requested normalized energy reservations is less than or equal to the predefined maximum total normalized energy reservation, and the final normalized energy reservation corresponds to the requested normalized energy reservation.

Aspect 16: The method of Aspect 14, wherein the sum of requested normalized energy reservations is greater than the predefined maximum total normalized energy reservation, the final normalized energy reservation is based at least in part on a distribution of an extra normalized energy among the plurality of radios, and the distribution is based at least in part on priorities associated with the plurality of radios, respectively, and the requested normalized energy reservation.

Aspect 17: The method of any of Aspects 11-16, wherein the radio is guaranteed a predefined minimum energy reservation, and an extra available energy reservation is distributed among the plurality of radios based at least in part on one or more of: priorities of the plurality of radios, actual past energy usage, or energy reservations for control channels and high-priority services.

Aspect 18: An apparatus for wireless communication at a device, comprising a processor; memory coupled with the processor; and instructions stored in the memory and executable by the processor to cause the apparatus to perform the method of one or more of Aspects 1-17.

Aspect 19: A device for wireless communication, comprising a memory and one or more processors coupled to the memory, the one or more processors configured to perform the method of one or more of Aspects 1-17.

Aspect 20: An apparatus for wireless communication, comprising at least one means for performing the method of one or more of Aspects 1-17.

Aspect 21: A non-transitory computer-readable medium storing code for wireless communication, the code comprising instructions executable by a processor to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
one or more memories; and
one or more processors coupled to the one or more memories, the one or more processors individually or collectively configured to:
determine, for a radio associated with a user equipment (UE), an energy usage in a past transmit interval;
determine, for the radio, a requested usage-aware energy reservation based at least in part on the energy usage in the past transmit interval;
assign, for a next transmit interval, an energy budget limit for the radio based at least in part on the requested usage-aware energy reservation; and
transmit, via the radio, an uplink transmission based at least in part on the energy budget limit.

2. The apparatus of claim 1, wherein the one or more processors are individually or collectively configured to:
calculate, for a transmit interval, a normalized energy usage ratio as a ratio between the energy usage in the past transmit interval and a minimum of an allocated energy limit in the past transmit interval and a reference input maximum transmit energy limit.

3. The apparatus of claim 2, wherein the normalized energy usage ratio is less than or equal to one, and the reference input maximum transmit energy limit is a maximum allowed energy limit for the radio under a corresponding transmit antenna based at least in part on an uplink duty cycle satisfying a threshold and the radio being an only active radio of the UE.

4. The apparatus of claim 2, wherein the one or more processors are individually or collectively configured to:
calculate the requested usage-aware energy reservation based at least in part on the normalized energy usage ratio multiplied by the reference input maximum transmit energy limit.

5. The apparatus of claim 2, wherein the one or more processors are individually or collectively configured to:
obtain a filtered normalized energy usage ratio, from the normalized energy usage ratio, using a filter; and
calculate the requested usage-aware energy reservation based at least in part on the filtered normalized energy usage ratio multiplied by the reference input maximum transmit energy limit.

6. The apparatus of claim 1, wherein the one or more processors are individually or collectively configured to:
determine a true requested energy reservation for a control channel and high-priority traffic, wherein the true requested energy reservation is based at least in part on a sum of a control channel energy reservation and a requested high-priority traffic energy reservation; and
calculate the requested usage-aware energy reservation based at least in part on the true requested energy reservation.

7. The apparatus of claim 2, wherein the one or more processors are individually or collectively configured to:
determine a true requested energy reservation for a control channel and high-priority traffic, wherein the true requested energy reservation is based at least in part on a sum of a control channel energy reservation and a requested high-priority traffic energy reservation; and
calculate the requested usage-aware energy reservation based at least in part on a maximum of the true requested energy reservation and the normalized energy usage ratio multiplied by the reference input maximum transmit energy limit.

8. The apparatus of claim 2, wherein the one or more processors are individually or collectively configured to:
determine a true requested energy reservation for a control channel and high-priority traffic, wherein the true requested energy reservation is based at least in part on a sum of a control channel energy reservation and a requested high-priority traffic energy reservation;
obtain a filtered normalized energy usage ratio, from the normalized energy usage ratio, using a filter; and
calculate the requested usage-aware energy reservation based at least in part on a maximum of the true requested energy reservation and the filtered normalized energy usage ratio multiplied by the reference input maximum transmit energy limit.

9. The apparatus of claim 1, wherein the one or more processors are individually or collectively configured to:
determine an available energy limit for best-effort traffic data, wherein the available energy limit for best-effort traffic data is a function of the energy budget limit and a true requested energy reservation, and the available energy limit for best-effort traffic data corresponds to a remaining available transmit energy for best-effort traffic.

10. The apparatus of claim 1, wherein the UE is configured with multiple antenna groups, and the radio is associated with an antenna group of the multiple antenna groups.

11. The apparatus of claim 1, wherein the radio is associated with an energy usage aware dynamic energy reservation under a specific absorption rate (SAR) limit or a maximum permissible exposure (MPE) limit, and a dynamic energy reserve level of the radio is based at least in part on actual past energy usage by the radio and required energy for the radio to transmit control data and high-priority traffic.

12. An apparatus for wireless communication, comprising:
one or more memories; and
one or more processors coupled to the one or more memories, the one or more processors individually or collectively configured to:
determine, for a radio of a plurality of radios associated with a user equipment (UE), a requested normalized energy reservation;
determine, for the radio, a final normalized energy reservation based at least in part on a sum of requested normalized energy reservations, associated with the plurality of radios, and a predefined maximum total normalized energy reservation;
determine, for the radio, an energy usage in a past transmit interval;
determine, for a next transmit interval, an energy budget limit for the radio based at least in part on the final normalized energy reservation and the energy usage in the past transmit interval; and
transmit, via the radio, an uplink transmission based at least in part on the energy budget limit.

13. The apparatus of claim 12, wherein the one or more processors are individually or collectively configured to:
allocate, for the radio, a predefined minimum normalized energy reservation.

14. The apparatus of claim 12, wherein the requested normalized energy reservation is a requested usage-aware energy reservation divided by a reference input maximum transmit energy limit.

15. The apparatus of claim 12, wherein the one or more processors are individually or collectively configured to:
determine whether the sum of requested normalized energy reservations, associated with the plurality of radios, exceeds the predefined maximum total normalized energy reservation.

16. The apparatus of claim 15, wherein the sum of requested normalized energy reservations is less than or equal to the predefined maximum total normalized energy reservation, and the final normalized energy reservation corresponds to the requested normalized energy reservation.

17. The apparatus of claim 15, wherein the sum of requested normalized energy reservations is greater than the predefined maximum total normalized energy reservation, the final normalized energy reservation is based at least in part on a distribution of an extra normalized energy among the plurality of radios, and the distribution is based at least in part on priorities associated with the plurality of radios, respectively, and the requested normalized energy reservation.

18. The apparatus of claim 12, wherein the radio is guaranteed a predefined minimum energy reservation, and an extra available energy reservation is distributed among the plurality of radios based at least in part on one or more of: priorities of the plurality of radios, actual past energy usage, or energy reservations for control channels and high-priority services.

19. A method of wireless communication performed by a user equipment (UE), comprising:
determining, for a radio associated with the UE, an energy usage in a past transmit interval;
determining, for the radio, a requested usage-aware energy reservation based at least in part on the energy usage in the past transmit interval;
assigning, for a next transmit interval, an energy budget limit for the radio based at least in part on the requested usage-aware energy reservation; and
transmitting, via the radio, an uplink transmission based at least in part on the energy budget limit.

20. The method of claim 19, further comprising:
calculating, for a transmit interval, a normalized energy usage ratio as a ratio between the energy usage in the past transmit interval and a minimum of an allocated energy limit in the past transmit interval and a reference input maximum transmit energy limit.

21. The method of claim 20, wherein the normalized energy usage ratio is less than or equal to one, and the reference input maximum transmit energy limit is a maximum allowed energy limit for the radio under a corresponding transmit antenna based at least in part on an uplink duty cycle satisfying a threshold and the radio being an only active radio of the UE.

22. The method of claim 20, further comprising:
calculating the requested usage-aware energy reservation based at least in part on the normalized energy usage ratio multiplied by the reference input maximum transmit energy limit.

23. The method of claim 20, further comprising:
obtaining a filtered normalized energy usage ratio, from the normalized energy usage ratio, using a filter; and
calculating the requested usage-aware energy reservation based at least in part on the filtered normalized energy usage ratio multiplied by the reference input maximum transmit energy limit.

24. The method of claim 19, further comprising:
determining a true requested energy reservation for a control channel and high-priority traffic, wherein the true requested energy reservation is based at least in part on a sum of a control channel energy reservation and a requested high-priority traffic energy reservation; and
calculating the requested usage-aware energy reservation based at least in part on the true requested energy reservation.

25. The method of claim 20, further comprising:
determining a true requested energy reservation for a control channel and high-priority traffic, wherein the true requested energy reservation is based at least in part on a sum of a control channel energy reservation and a requested high-priority traffic energy reservation; and
calculating the requested usage-aware energy reservation based at least in part on a maximum of the true requested energy reservation and the normalized energy usage ratio multiplied by the reference input maximum transmit energy limit.

26. The method of claim 19, further comprising:
determining an available energy limit for best-effort traffic data, wherein the available energy limit for best-effort traffic data is a function of the energy budget limit and a true requested energy reservation, and the available energy limit for best-effort traffic data corresponds to a remaining available transmit energy for best-effort traffic.

27. A method of wireless communication performed by a user equipment (UE), comprising:
determining, for a radio of a plurality of radios associated with the UE, a requested normalized energy reservation;
determining, for the radio, a final normalized energy reservation based at least in part on a sum of requested normalized energy reservations, associated with the plurality of radios, and a predefined maximum total normalized energy reservation;
determining, for the radio, an energy usage in a past transmit interval;
determining, for a next transmit interval, an energy budget limit for the radio based at least in part on the final normalized energy reservation and the energy usage in the past transmit interval; and
transmitting, via the radio, an uplink transmission based at least in part on the energy budget limit.

28. The method of claim 27, further comprising:
allocating, for the radio, a predefined minimum normalized energy reservation; and
determining whether the sum of requested normalized energy reservations, associated with the plurality of radios, exceeds the predefined maximum total normalized energy reservation,
wherein the requested normalized energy reservation is a requested usage-aware energy reservation divided by a reference input maximum transmit energy limit.

29. The method of claim 27, wherein the sum of requested normalized energy reservations is less than or equal to the predefined maximum total normalized energy reservation, and the final normalized energy reservation corresponds to the requested normalized energy reservation.

30. The method of claim 27, wherein the sum of requested normalized energy reservations is greater than the predefined maximum total normalized energy reservation, the final normalized energy reservation is based at least in part on a distribution of an extra normalized energy among the plurality of radios, and the distribution is based at least in part on priorities associated with the plurality of radios, respectively, and the requested normalized energy reservation.
